(19) United States
(12) Patent Application Publication
(10) Pub. No.: US 2022/0134718 A1
(43) Pub. Date: May 5, 2022

(54) ADHESIVE-FREE LAMINATES AND METHOD FOR MAKING

(71) Applicant: Amcor Flexibles North America, Inc, Neenah, WI (US)

(72) Inventors: Daniel C. Vernerberg, Neenah, WI (US); Jacob A. Lasee, Neenah, WI (US); Bratt P. Bobke, Oshkosh, WI (US)

(21) Appl. No.: 17/430,349

(22) PCT Filed: Mar. 21, 2019
(86) PCT No.: PCT/US2019/023476

§ 371 Date: Aug. 12, 2021

(51) Int. Cl. B32B 27/08; C09D 11/101; B32B 7/12; B32B 27/32; B32B 38/00; B32B 37/12; G09F 3/02

(52) U.S. Cl. CPC B32B 27/08; G09F 2003/0255; B32B 7/12; B32B 27/32; B32B 38/145; B32B 37/12; G09F 3/02; B32B 2307/4026; B32B 2307/518; B32B 2255/10; B32B 2255/26; B32B 2307/75; B32B 2307/412; B32B 2310/0831; B32B 2250/02; B32B 2250/242; B32B 2519/00; B32B 2553/00; G09F 2003/0202; C09D 11/101

(57) ABSTRACT

An adhesive-free laminate and a process for producing such a laminate are described herein. The process includes printing an ink on the surface of a first film, exposure of the printed film to UV radiation such that the ink is at least partially cured, attaching the first film to a second film such that the ink is between the first and second film, and exposing the combination of the first film, the ink and the second film to a second UV radiation. It has been found that this process can produce a unique laminate, without the presence of an adhesive.

### TECHNICAL FIELD

This disclosure relates to film structures, in particular adhesive-free laminates, and a process to produce them. The laminates described herein may be useful for roll-fed labels, packaging films or other similar applications.

### BACKGROUND

Printed laminates for labels, packaging films or other similar applications are often produced in a manner such that the printed graphics (e.g. indicia or pictures) are trapped between two films. This construction provides protection to the inks, preventing the ink from being scuffed off or otherwise damaged and maintaining a high-quality appearance.

To produce this “trapped print” construction, the converter typically uses a standard printing process to apply ink to the surface of a film. The ink is then dried by the appropriate means (i.e. heated air for water or solvent based inks, high energy radiation for radiation curable inks, etc.). Then, the printed film is attached to a second film, thereby trapping, the ink.

One typical approach to attaching the second film is by adhesive lamination. An adhesive material is applied to either one of the films and the films are brought into contact with each other. There are many types of adhesives and application method options known in the industry for lamination of a printed film to another film. The type of adhesive and process used is usually dictated by performance requirements and cost.

The adhesives used for medium- or high-performance applications are typically reactive in nature. The adhesives have two components that are mixed just prior to application and chemically react to form thermoset, permanently bonding the films. These high-performance adhesives can have a significant cost. The application of these adhesives to the laminate structure adds both material and processing costs to the final product.

Another approach to attaching a film to a printed a film is by a thermal process, This can be done by several known methods including extrusion lamination or thermal lamination. Extrusion lamination involves attaching the second film to the first film using an adhesive polymer heated to the melt phase. The inched polymer is brought into. contact with the second film and the printed film and is cooled to form the bond. The fluid like melted polymer can flow and provide enough entanglement with the surface of the first film such that the two remain physically connected when the melt is cooled. Similarly, thermal lamination involves bringing the first and or second film to a temperature above the materials softening point and then attaching the films under pressure, In other words, the films used in thermal lamination have a heat sensitive adhesive material within the film. The heat softened surface(s) create entanglements and can result a strong bond upon cooling.

These thermal processes for lamination have significant drawbacks. The temperature that is required to create the bond can cause damage to the films and/or the inks, causing them to shrink or have poor appearance properties. Additionally, the materials that work well for thermal adhesion are often specialty type materials that have no other function within the laminate. The addition of these specialty materials for the sole purpose of bonding adds significant cost to the process of lamination.

A process is needed to simplify bonding for these types of laminations.

### SUMMARY

There is a need for a simplified laminate structure and a process to produce the simplified laminate efficiently. Herein is described a general laminate structure including a first film, a second film and an ink between, and attached to, each film. The laminate has sufficient bonds for applications including labels and packaging without the use of a standard adhesive material.

Disclosed herein are adhesive-free laminate structures having a) a first film, b) a second film and c) an ink. The ink is located between the first film and the second film and is adhered to a surface of the first film and a surface or the second film. Each of the first film and the second film are oriented.

In some embodiments of the adhesive-free laminate, the ink has been cured by a radiation source having a wavelength of between 200 nm and 400 nm (ultraviolet light). The bond between the ink and the second film has been increased b exposure to radiation. The ink may contain a pigment. The ink may contain a photo initiator. The ink may be configured to relay a visual message.

Embodiments of the adhesive-free laminate may have bonds measured between the second film and the ink of at least 50 g/in. In some cases, the adhesive-free laminate structure includes a first film of biaxially oriented polypropylene or biaxially oriented polyester. Similarly, the second film may be biaxially oriented polypropylene or biaxially oriented polyester. The surface of the second film that is in contact with the ink may have a softening point above 250° F. Some embodiments of the adhesive-free laminate have ink that is coextensive with both the first film and the second film.

Also described herein are embodiments of processes to produce an adhesive-free laminate. The processes include printing a UV radiation sensitive ink on a surface of a first film, exposing the first film and the UV radiation sensitive ink to a first UV radiation such that the UV radiation sensitive ink is at least partially cured, attaching the first film to a second film such that 1) the UV radiation sensitive ink is between the first film and the second film and 2) the UV radiation sensitive ink is in direct contact with a surface of the second film, and exposing the combination of the first film, the UV radiation sensitive ink and the second film to a second UV radiation. Both the first film and the second film used in the process may be oriented films. The process may produce an adhesive-free laminate in which both the first and second films are each a biaxially oriented polypropylene.

During the process to produce an adhesive-free laminate, the first UV radiation and the second UV radiation may impinge opposite sides of the UV radiation sensitive ink. Alternatively, the first UV radiation and the second UV radiation may impinge the same side of the UV radiation sensitive ink.

The UV radiation sensitive ink may be less than fully cured upon exposure to the first UV radiation. The second UV radiation may be employed when the combination of the first film, the UV radiation sensitive ink and the second film is at a temperature between about 100° F. and 200° F.

Some embodiments of a process to produce an adhesive-free laminate include a first step of printing a UV radiation sensitive ink on a surface of a first film, a second step of exposing the first film to a first UV radiation such that the UV radiation sensitive ink is at least partially cured, a third step of attaching the first film to a second film such that the UV radiation sensitive ink is between the first film and the second film and the UV radiation sensitive ink is in direct contact with a surface of the second film, and a fourth step of exposing the combination of the first film, the UV radiation sensitive ink and the second film to a second UV radiation such that the bonds measured when separating the first film and the second film are between 100 g/in and 500 g/in. The fourth step may include heating the combination of the first film, the UV radiation sensitive ink and the second film using an external heating source immediately prior to exposure to the second UV radiation. The third step may be carried out when the second film is at a temperature below the softening point of the surface of the second film. The UV radiation sensitive ink may be less than fully cured during the second step. The first and second films used in the process may be oriented films.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic of an embodiment of an adhesive-free laminate;

FIG. 2 is a schematic of another embodiment of an adhesive free laminate;

FIG. 3 is a schematic of an embodiment of a process used to produce an adhesive-five laminate;

FIG. 4 is a graph showing bond strength as a function of temperature for an embodiment of an adhesive-free laminate; and

FIG. 5 is a graph showing bond strength as a function of time for an embodiment of an adhesive-free laminate.

The drawings show some but not all embodiments. The elements depicted in the drawings are illustrative and not necessarily to scale, and the same (or similar) reference numbers denote the same (or similar) features throughout the drawings.

### DETAILED DESCRIPTION

It has been found that an adhesive-free laminate can be produced by way of a specific manufacturing process that includes at least two energy radiation stops. The process results in an adhesive-free packaging structure containing a radiation sensitive ink between a first and second film. The laminate structure includes two films and the material between these films consists of ink. The ink is configured to convey a visual message. The laminate is processed by a series of UV irradiation steps, increasing the bond within the laminate and eliminating the need for an adhesive type material. This process is especially useful when both the first and second films are oriented. The films can be bonded without the use of a typical adhesive, reducing the materials required for the laminate and complexity of producing the laminate.

The adhesive-free laminates described herein may be particularly useful for roll-fed label applications, packaging films, and specifically food packaging. The elimination of traditional adhesive in these laminates reduces the complexity of the converting process and reduces costs. The laminates disclosed herein are of suitable performance and appearance for these applications. Further, the process described herein does not use high temperatures to achieve bonding, allowing for a wider selection of films and inks, and resulting in a higher quality laminate.

Surprisingly it was found that strong bonding can be achieved between a film that has been printed with a UV ink and an oriented film, without the use of adhesive. As disclosed in WO2016050686 (PCT application filed Sep. 28, 2015 by Centonze, et al) it is known that an unoriented film can be attached to a printed film without the use of adhesive. The method disclosed by Centonze et al includes a thermal method of attachment, requiring an unoriented film with a low softening point. Similarly, a method disclosed U.S. Pat. No. 7,281,360 (granted Oct. 16, 2007 to Larimore, et al) uses an unoriented extrudate layer to provide for thermal attachment to a printed film. Advantageously, the laminate structures and processes disclosed herein do not include an adhesive or any other additional layer to attach an oriented film to a printed film, nor do they feature potentially damaging high processing temperatures.

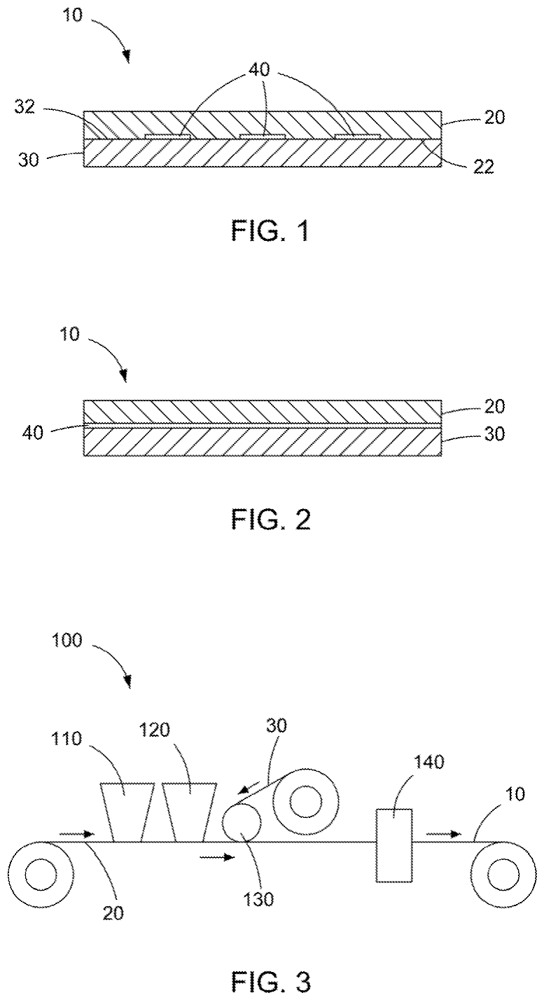

The adhesive-free laminates generally have a structure of a first film, a second film and an ink located between the films. The ink is in direct contact with a surface of the first film and a surface of the second film. The first film, the ink and the second film are all bonded to each other at their contacting surfaces. There is no adhesive material between the first film and the second film of the adhesive-free laminate. This general structure can be seen in the schematic of the adhesive-free laminate shown in FIG. 1. The adhesive-free laminate 10 comprises a first film 20 connected to a second film 30. An ink 40 is located between the films. The ink 40 is in contact with a surface of the first film 22 and the ink 40 is in contact with a surface of the second film 32. The ink can be seen through either the first film, the second film or both films.

The first film 20 of the adhesive-free laminate is a polymeric based film. As used herein the term “film” is a mono-layer or multi-layer web that has an insignificant z-direction dimension (thickness) as compared to its x- and y-direction dimensions (length and width), very similar to a piece of copy paper. Films are generally regarded as having two major surfaces, opposite each other, expanding in the length and width directions. Films that would be useful as the first film may have a thickness from 8 microns to 100 microns. Ideally, the first film has a thickness from 12 microns to 75 microns.

As used herein, “layers” are homogeneous building blocks of films that are bonded together. Layers may be continuous or discontinuous (i.e. patterned) with the area of the film.

Ideally, the first film has high clarity, gloss and UV transmissivity. Several types of polymer materials may be utilized in the first film with high success. The first film may have a special coating or treatment to enhance the printability of the film, as is known in the art.

The first film may be oriented. The film may be biaxially oriented or mono-axially oriented in either length find or width direction. The first film is preferably heat set (i.e. annealed) such that it is dimensionally stable under elevated temperature conditions that might be experienced during conversion of the laminate or during the use of the laminate.

The first film may be an oriented polypropylene film, such as biaxially oriented polypropylene. The oriented polypropylene film may have one or more layers and may have specialized coatings, such as matte finish. The oriented polypropylene film may have some layers that do not contain polypropylene but preferably has at least one surface layer that contains polypropylene. Any of the layers of the oriented polypropylene film may contain a pigment, such as titanium dioxide, to make the film colored and/or opaque to visible light. The first film may be a cavitated biaxially oriented polypropylene, resulting in a film that is white and substantially opaque to visible light. The biaxially oriented polypropylene may be clear to visible light. In some embodiments, the first film is a biaxially oriented polypropylene film that essentially comprises polypropylene.

The first film may be an oriented polyester film, such as biaxially oriented polyester. The oriented polyester may have one or more layers and may have specialized coatings, such, as acrylic. The oriented polyester may have some layers that do not contain polyester. Ideally, the oriented polyester film has at least one surface layer that contains polyester. Any of the layers of the oriented polyester may contain a pigment, rendering the film opaque to visible light. The oriented polyester may be clear to visible light. In some embodiments, the first film is a biaxially oriented polyester film that essentially comprises polyester.

Typically, oriented polyester films have low transparency to UV energy, as compared to other polymeric films. However, this may be acceptable to the process described herein. For example, it may be suitable to use a polyester film as the first film if the second film is highly transmissive to UV energy and the UV radiation is impinged upon the second film. Additionally, if a polyester film or other low UV energy transmittance film is used, it may be possible to use a very high intensity or wide-spectrum UV radiation source to impinge a high enough amount of UV energy through the film for curing and bonding to take place.

Non-limiting examples of commercial films that would be suitable for use as the first film of the adhesive-free laminate are as follows: Grade J-201(8-50 micron) biaxially oriented polyester film available from Jindal Poly Films, Skyrol® Grade SP65 (8-36 micron) biaxially oriented polyester available from SKC, Sarafil Grade TFC (8-50 micron) biaxially oriented polyester available from Polyplex, FLEXPET™ Grade F-PAP (8-75 micron) available from Flex America, Hostaphan® Grade 2602N chemically primed biaxially oriented polyester available from Mitsubishi Polyester Film, Hostaphan® Grade 2CSRN chemically primed biaxially oriented polyester available from Mitsubishi Polyester Film, Hostaphan® Grade 2MRLN chemically primed biaxially oriented polyester film available from Mitsubishi Polyester Film, Grade F-AUT (10-23 micron) biaxially oriented polyester available from Flex America, Bicor™ Grade SLP (15-30 micron) biaxially oriented polypropylene available from Jindal Films, Bicor™ Grade CSR-2 (15-30 micron) biaxially oriented polypropylene available from Jindal Films, Grade T523-3 (12-31 micron) biaxially oriented polypropylene available from Taghleef Industries, Grade RLS (12-31 micron) biaxially oriented polypropylene available from Taghleef industries, Grade PST-2 (15-36 micron) biaxially oriented polypropylene available from Taghleef Industries, Grade AQS (18-31 micron) biaxially oriented polypropylene available from Taghleef Industries, and Grade CTL (12-31 micron) biaxially oriented polypropylene available from Taghleef Industries. The first film can be of any thickness suitable for the application it is intended for.

As will be described, an ink is applied to one of the surfaces of the first film. Inks for printing polymeric films are widely known and may be of a type that can be applied in a variety of methods (i.e. flexographic printing, gravure printing, digital printing, offset printing, etc.). The ink may contain an inorganic or organic pigment, surfactants or other dispersing agents, resins for managing binding or mechanical properties, rheology modifiers, defoamers, wetting agents, solvents, or pH modifiers. The ink may contain other additives to adjust viscosity or other processing variables.

The ink may be configured to relay a visual message. In order to relay the message, the ink should be visible from either or both sides of the adhesive-free laminate. The visual message may be intended to be viewed by a human and may take the form of product logos, product instructions/information, branding colors/shapes, etc. The visual message may be intended to be read by a machine and may take the form of a code (i.e. bar code or serial number).

The ink of the adhesive-free laminates described herein should be one that is sensitive to radiation, especially ultra-violet (UV) radiation. UV radiation sensitive inks have various components that react to energy that has wavelengths in the UV range (roughly 200 to 400 nm), such that the ink polymerizes and/or cross-links, increasing the inks viscosity, and ultimately changing from a liquid to a solid. Typically, this reaction is started by exposure to UV radiation and then either stops or slowly continues after the exposure is terminated. In some cases, the UV radiation is first absorbed by photo initiators within the ink formula. The photo initiators absorb the energy and create free radicals which further react with the ink components.

The process of initiating the reaction and continuing until the reaction stops is called “curing”. The UV curing reaction may be influenced (i.e. faster kinetics) by increased temperature. Curing may continue until there are no more reaction sites to consume (full cure) or it may end due to lack of energy (partial cure). Under appropriate conditions, as the ink polymerizes and/or cross-links, the ink may also form bonds across the interface to the layer (film or other material) that is located adjacent to the ink. Thus, curing the UV radiation sensitive ink may increase the bond the ink has to the film the ink has been applied to, or another film the ink may be in contact with. The increase in bond strength may be dependent upon the film, some films providing better bonding opportunities than others. Conventional, non-curing inks used for packaging and label applications, such as solvent based polyurethane chemistry inks or nitrocellulose chemistry inks, are not reactive to UV energy and would not be suitable to use in the adhesive-free laminates or processes used to produce the adhesive-free laminates described herein, without modification.

In addition to traditional UV radiation sensitive inks, it is contemplated that other ink formulations may be suitable for use in adhesive-free laminates. For example, inks that do not contain photoinitiators, but otherwise react upon exposure to UV radiation may be developed and would be appropriate for embodiments of adhesive-free laminates.

There may be multiple layers of ink between the first film and the second film. There may be more than one color of ink applied to the first film.

Non-limiting examples of commercial UV radiation sensitive inks that would be suitable for use in the adhesive-free laminate are as follows: Fujifilm 300 series inks such as 300-325, INX INXFlex™ UV LM, and Siegwerk SICURA Flex 39-10.

The second film of the adhesive-free laminate is a polymeric based film. The films that would be useful as the second film may be mono-layer or multi-layer and may have a thickness from 10 microns to 100 microns. Ideally, the second film has a thickness of between 12 microns and 75 microns.

Ideally, the second film has high clarity, gloss and UV transmissivity. Preferably, the second film is highly transparent to UV energy over a wide range of the UV spectrum. However, the second film may have lower transparency to UV energy or may only be transmissive over a portion of the UV spectrum. Several types of polymer materials may be utilized as the second film with high success. Any film that is suitable as the first film would be suitable as the second film, with the exception for films that are completely opaque to UV radiation. In any embodiment of the adhesive-free laminate, the second film may be identical to the first film. In any embodiment of the adhesive-free laminate, the second film may be different than the first film.

The second film may be oriented. The second film may be biaxially oriented or mono-axially oriented in either direction. The second film is preferably heat set such that it is dimensionally stable under elevated temperature conditions.

The second film may be an oriented polypropylene film, such as biaxially oriented polypropylene. The oriented polypropylene film can have one or more layers and may have specialized coatings, such as matte finish. The oriented polypropylene film may have some layers that do not contain polypropylene but must have at least one surface layer that contains polypropylene. Any of the layers of the oriented polypropylene film may contain a pigment, such as titanium dioxide, to make the film opaque to visible light. However, a pigmented second film may not be transparent to UV energy, which is only acceptable if the first film of the adhesive-free laminate is at least partially UV transparent.

The second film may be an oriented polyester film, such as biaxially oriented polyester. The oriented polyester can have one or more layers and may have specialized coatings, such as acrylic. The oriented polyester film may have some layers that do not contain polyester. Ideally, the oriented polyester film has at least one surface layer that contains polyester. Any of the layers of the oriented polyester may contain a pigment, rendering the film opaque to visible light.

Other types of oriented films may be used for the second film as well. For example, a biaxially oriented or mono-axially oriented polyethylene film may be used as the second film.

Referring now to FIGS. 1 and 2, embodiments of the adhesive-free laminate 10 comprise of the first film 20, the second film 30 and the ink 40. The ink 40 is adhered to a surface of the first film 22 and the ink 40 is adhered to a surface of the second film 32 and the ink is located between the first and second film. As shown in FIG. 1, the ink 40 may be patterned and not continuous with either the first or second film 20,30. In some embodiments of the adhesive-free laminate 10, the ink 40 is coextensive with both the first film 20 and the second film 30, as shown in FIG. 2. In either of the embodiments shown in FIGS. 1 and 2, the ink is configured such that a person or machine can visually receive a message by way of viewing the ink.

As shown in the embodiments of FIGS. 1 and 2, the adhesive-free laminates 10 include the first film 20 and the second film 30 attached to each other with only the ink 40 intervening. The ink 40 is adhered to both the first film 20 and the second film 30. In other words, the bond between the ink and the first film is greater than zero and the bond between the ink and the second film is greater than zero. There is no adhesive material assisting with the attachment of the ink to the first film. There is no adhesive material assisting with the attachment of the ink to the second film. In the areas where the surface of the first film 22 is in contact with the surface of the second film 32, there is no other material intervening. in the areas where the surface of the first film 22 is in contact with the surface of the second film 32. the films may or may not be bonded to each other. Ideally, if there are portions of the surfaces of the films 22,32 that do not have ink in contact with them, the two films are in intimate contact and have a bond strength greater than 0 g/in, preferably greater than 20 g/in.

The ink may be bonded to the first film and/or the second film and the bond may be enhanced by exposure to UV radiation. Evidence of this may be by detection of an increased bond strength after exposure to a UV radiation source. Without being bound by theory, the reaction of the UV radiation sensitive ink under UV radiation exposure may include creation of chemical bonds across the ink/film interface, thus providing increased bond strength. The ink bond strength to the first and/or second film may increase after exposure to the UV radiation sources as described by the process to produce an adhesive free laminate described herein.

As described herein, the embodiments of adhesive-free laminates and the embodiments of processes to produce adhesive-free laminates do not include adhesive in the portion of the structure defined as the first film, the ink and the second film, in the arrangements described herein. However, there may be adhesive type components in the remainder of the laminate structure (i.e. adhesive may be present in layers adjacent to the second film on the surface not connected to the ink).

In the process of converting labels and packaging laminates, adhesives that may be used to connect layers come in a variety of formats and generally have the purpose of enabling dissimilar material to be bonded together. Typical adhesives are one- or two-component materials, applied to a film in liquid form prior to connecting to another film. These adhesives typically use polyurethane acrylic or epoxy amine type chemistry. Typically, adhesives are applied over the entire surface of a film (i.e. not patterned) and are not visible by looking through the film being bonded. Liquid applied adhesives have several disadvantages including solvent removal and disposal (high cost and energy impact) and extended cure time (costly for production). In some cases, the addition of liquid applied adhesive layers for bonding negatively affects other characteristics, such as stiffness.

Also used in labels and packaging laminates are polymer-based adhesives that are extruded into or onto a film. Typical polymer-based adhesives take the form of tie layers within coextruded films, adhesive layers within extrusion laminations or adhesive layers within extrusion coating, to name a few. The polymers used for these types of adhesives take various forms, but generally have lower softening points and a high level of active bonding sites to help with adhesion to various materials. Examples of these types of adhesives are maleic anhydride grafted polyolefins, ethylene vinyl acetate copolymers or similar materials. These materials bond to adjacent materials when they come into contact while in the melted state (i.e. coextrusion) and are readily known to those skilled in the art.

Soft types of polymers used as adhesives in coextrusion or extrusion lamination may also be used as adhesive in thermal lamination processes. During thermal lamination, the adhesive material is not in the melt phase, but rather in a softened state by way of heating. Once softened by heating, the adhesive material is brought into contact with another material, creating intimate and often intermingled physical contact. Upon cooling, this intermingled contact creates a bond between the materials.

Pressure-sensitive adhesives (PSAs) may also be used as adhesives in laminates. PSAs are typically a blend of lower molecular weight materials that results in a material that remains soft and tacky through the useful life of the PSA.

In contrast, the adhesive-free laminates described herein do not use adhesives of these types (e.g. applied liquids, melted or softened polymers, PSA) to create a bond between the first film, the ink and the second film. The bond is created by specific processing of the laminate, including, two separate UV radiation exposures. The process has the advantages of efficiency (no adhesive application) and low cost (no adhesive materials). The adhesive-free laminate produced by this process has the advantage of ease of design (i.e. films and inks do not need to withstand high heats).

The adhesive-free laminates made by the process described herein do not contain typical adhesive type components. There is no material that was applied as a liquid with the sole purpose of bonding two surfaces to each other. There is no material either between the films nor within the film surfaces, that has a low softening point such that thermal lamination can take place. This is in direct contrast to currently available laminates that utilize specialized adhesive materials, either between the films or within the films, to achieve bonding.

The softening point of a polymer or a film is often defined by a given measurable attribute using a known method such as the Vicat method (ASTM-D1525) or a heat deflection method (ASTM-D648). In some cases, a polymer has a glass transition point which can define a softening point. As described herein, the softening point of a polymer or film is a temperature above which the material, takes a state in which it can be attached to another surface and a strong bond is achieved after cooling the material below the softening point temperature. The material above the softening point is in a softened condition and may have more physical mobility such that it can increase the bonding surface area when brought into intimate contact with another surface. Sometimes, this increase in surface area is called “wetting”. Materials that have been heated above their softening point may have increased wetting to another surface, increasing the bonding force between them.

One advantage to the adhesive-free laminates and tile processes to produce them as disclosed herein, is that no additional adhesive materials are required to bond the ink to the films. When the first film and the second film are oriented films, it can be difficult to bond the films without adhesive due to their high softening point. High temperatures, at least temperatures above about 250° F., would be required to soften films such as oriented polyester or oriented polypropylene to a point where the materials could be thermally bonded. Oriented polyester and oriented polypropylene have softening points above 250° F. and would need to be heated to temperatures above that point to make thermal lamination possible. Heating to such a high temperature may introduce detrimental effects, such as shrinking or deforming the films or degrading the ink that is between the films.

As stated, there are no adhesive materials within the portion of the laminate defined by the surface of the first film, the UV radiation sensitive ink and the surface of the second film. However, adhesives may be used in other portions of the laminate, such as on the surface of the second film directed away from the UV radiation sensitive ink. Other films may be laminated to the embodiments described herein using conventional adhesive and conventional laminating processes. For example, an embodiment of the adhesive-free laminate may include a PSA material on the exterior surface (the surface opposite that which is in contact with the ink) of either the first or second film such that the laminate is functional as a PSA label.

Some embodiments of the adhesive-free laminate have a first film an ink that contains a pigment and a second film. In some embodiments, both the first film and the second film are oriented films. In some embodiments, the ink is one that has been cured by UV radiation. In some embodiments, both the first and second film are biaxially oriented polypropylene. The adhesive-free laminates do not contain adhesive between the first film and the second film. The ink of the adhesive-free laminates is adhered directly to the surface of the first film and the ink of the adhesive-free laminates is adhered directly to the surface of the second film. The ink of the adhesive-free laminates may be configured to relay a visual message.

Some embodiments of the adhesive-free laminate may include other layers or materials. For example, there may be additional ink on the first film or the second film, located on a surface opposite that of the UV radiation sensitive ink. Additional films, coatings, layer or materials may also be added to the laminate, without exclusion, as long as the UV radiation sensitive ink is adhered to the surface of the first film and the UV radiation sensitive ink is adhered to the surface of the second film and the UV radiation sensitive ink is between the first film and the second film.

Some embodiments of the adhesive-free laminate will include a sealant material, such as a heat sealant, enabling the laminate to be used in applications of high-performance hermetic packaging. The sealant material may be a layer of the second film, on the surface of the second film facing away from the UV radiation sensitive ink. The sealant material may be coated onto the surface of the laminate. The sealant may be pattern applied. The sealant may be attached to the laminate in the firm of a film, i.e. a third film connected to either the first film or the second film.

Some embodiments of the adhesive-free laminate will include a barrier material, suitable for reducing the transmission of oxygen, moisture, or other molecules through the laminate. Non-limiting examples of barrier materials that may be included in the adhesive-free laminates include oxygen or moisture scavengers, ethylene vinyl alcohol copolymers, metal foils, vapor depositions of metals or inorganics, high-density polyethylenes, cyclic olefin copolymers, polyamides, polyesters and exfoliated clay. The barrier material may be part of the first film, part of the second film, or introduced to the laminate as an additional film, coating or additive.

A critical attribute of most laminates is the bond strength. The components of the adhesive-free laminate should be assembled in a way that they will not delaminate from each other during use. The application in which a laminate is utilized often dictates the required bond strength. For example, packaging or label applications where the laminate experiences high stress and abuse may have a very high bond requirement, such that the laminate does not fail during use. Some applications of use have very low requirements either due to low risk or low abuse, and these laminates may require only minimal bond strengths. Bond strengths of laminates, can be measured according to ASTM F904 which measures the force required to separate layers of a laminate. As discussed herein, the bond strength of the adhesive-free laminate is measured using ASTM F904 (tested after conditioning at 23° C. and 50% relative humidity) to determine the force required to separate the first film from the second film.

The bond between the first film and the second film of the adhesive-free laminate may be in the range of 30 g/in to 1,000 g/in. The bond between the first film and the second film of the adhesive-free laminate may be in the range of 50 g/in to 750 g/in. The bond between the first film and the second film of the adhesive-free laminate may be between 50 g/in and 300 g/in, or higher. The bond of the adhesive-free laminate will likely vary within the same sample, depending on the color of the ink, the amount of ink or the presence of ink. In some cases, when measuring the bond between the first film and the second film, the bond between the films will be quite strong, causing one of the films to tear. The measured force of the film tearing is considered the bond strength for that sample (film tear is the mode of failure). The bond may open at the interface of the ink and the films or it may split within the ink. The location of bond fracture may vary and change as the hand is tested.

Surprisingly, strong bonds can be achieved within a lamination of film/ink/film without the need of an adhesive or the use of excessive heat. This is extremely advantageous to the processor of the laminate structure as an adhesive material and/or potentially damaging heat can be eliminated. The elimination of adhesive material provides a cost advantage over adhesive lamination.

Standard industry practice is to print a UV ink onto a substrate and immediately expose the ink to UV radiation with enough energy intensity and/or duration that the ink is fully cured. Standard industry trap printed laminations apply a second film to the printed film using an adhesive. It has been unexpectedly found that through a change in the converting process, as will be discussed, it is possible to achieve a bond between the printed film (the first film) and the second film without an adhesive. Elevated bonds can be achieved, without adhesive, by a UV energy exposure after the films have been attached to each other.

The thickness of the adhesive free laminate may be from 20 micron to 200 micron or more. While the portion of the adhesive-free laminate that is defined by the first film, the ink and the second film may be thin and flexible, some embodiments of the adhesive-free laminate may be quite thick and/or rigid due to additional layers or materials.

The adhesive-free laminates described herein may be used for a wide variety of applications. One exemplary application is roll fed labels. The structure of an oriented first web, an oriented second web and an ink between the webs is ideal for roll-fed labels. The bonds achieved by the embodiments described herein are acceptable for most roll-fed label applications and the lack of adhesive provides for a significant advantage over trap-printed label structures used today.

Another application that may benefit from the adhesive-free laminates described herein is packaging films. Films used to package food, pharmaceuticals, medical products, industrial items or consumer goods often use adhesive based laminate materials. Packaging would benefit from adhesive-free laminates due to converting process efficiency improvements and lower material costs. In particular, snack packaging typically uses thin, printed laminates of oriented films and could benefit from the adhesive-free laminates described herein.

It has been found that specific processing steps can be used to manufacture the adhesive-free laminates described herein with acceptable bonding for many applications. The process is less complicated and less expensive to implement than processes that include the incorporation of adhesives for laminate construction. The process disclosed herein also has advantages of lower temperatures required to induce bonding, as compared to thermal lamination or extrusion lamination techniques. Lower processing temperature is more favorable when converting films and inks that may be sensitive to high temperatures (i.e. heat shrinkable films).

Embodiments of the process of producing the adhesive-free laminates include at least four steps. The first step is printing a UV radiation sensitive ink on a surface of the first film. After printing, the first film is attached to a second film to create intimate contact between the second film and the ink. The first film is attached to the second film such that the UV radiation sensitive ink is between the films and the UV radiation sensitive ink is in direct contact with the second film. The attachment may be achieved by any number of known processes, such as nipping, between two rollers, applying pressure to the films. The first film and the ink may be exposed to a first UV radiation prior to attaching the second film to the ink. Alternatively, the first UV irradiation may occur after the second film has been attached to the ink. Finally, the combination of the first film, the ink and the second film is exposed to a second UV radiation to complete the process.

The process to produce the adhesive-free laminate 10 may incorporate all four of the necessary steps (110, 120, 130, 140) into one in-line process 100, as shown in FIG. 3. A roll of the first film 20 is unwound and passes through the first step, printing 110. Here, an ink (not shown) is applied directly to a surface of the first film. Next, the combination of the first film and the ink is exposed to a first UV radiation process 120 such that the ink is at least partially cured. Following the first UV radiation exposure, a second film 30 is unwound and attached to the combination of the first film and the ink, shown here as a pressure nipping type process 130. The films are attached such that the ink is between the films. The combination of the first film, the ink and the second film is then passed through a second UV radiation process 140 to complete the ink cure, if necessary, and increase bonding between the ink and the films. Finally, the adhesive-free laminate is wound onto a roll to await further converting. As will be described, the process to produce the adhesive-free laminate may be completed in a slightly different order of operations and the process may include additional steps, either in-line or out-of-line, to complete an embodiment of the structure. Alternatively, the steps of the process to produce the adhesive-free laminate may occur in more than one operation (i.e. not in-line).

The ink can be applied to the first web by any type of printing process. Typical processes used for film converting are flexographic gravure, rotogravure, digital, or off-set. The ink is applied in a liquid form and several different colors of ink may be applied to create the desired visual appearance and message. The ink may cover the entire web or nearly the entire web (i.e. ink is coextensive with the him) or may be patterned in any way. The ink may be applied in several layers, one layer partially or fulling overlapping another layer.

The materials used in the printing process are as previously described. The first film may be oriented and is ideally resistant to deformation at the temperatures used for printing. The ink may be of any type such that it is sensitive to UV radiation and can be cured and bonded to the first and second film under the process described herein. The ink may be a UV curable ink, as is known in the industry. If multiple layers of ink or multiple colors of ink are applied to the web, there may be a UV radiation step after each layer/color application. The individual UV irradiations that the first film and the ink may be exposed to during printing may collectively serve as the first UV radiation exposure of the processes described herein.

It is common in the label and packaging converting industries to use UV curable inks. The inks are specifically formulated to be of a liquid type viscosity prior to UV exposure, easily applied to a film by a process such as offset printing, digital printing or flexographic gravure. The inks are “sensitive” to UV radiation, typically by way of the addition of photo initiators. The photo initiators absorb energy at wavelengths specifically within the UV spectrum (approximately 200 to 400 nm). Upon absorption of the UV energy, the photo initiators dissociate to form free radicals. Other components within the ink (monomers, oligomers and reactive diluents) may contain double bonds capable of reacting with the free radicals. The reaction continues during, and possibly for a time following, the UV radiation exposure. The reaction builds longer chains of polymers and may even cause cross-linking between polymer chains, resulting in a rise in molecular weight and viscosity such that the ink transforms to a solid. This process is typically referred to as “curing”. The reaction changes the ink from “uncured”, through “partial cure”, to “fully cured”. As discussed, uncured ink has low viscosity. A partially cured ink has higher viscosity and may have characteristics spanning liquids (i.e. flowable) and solids (i.e. rigid). An ink that has been fully cured is solid. At full cure, the reaction ceases as there are no more bonds (or very few bonds) upon which the free radicals can react.

Similar to the reaction occurring within the ink during curing, chemical bonds may form across the interface of the ink and the film that it is in contact with, upon exposure to UV radiation. As discussed previously, the chemical bonds created across the interface of the ink and film may help increase the bond strength.

The UV radiation steps of the process to produce the adhesive-free laminate may be implemented in a variety of ways and may need to be adjusted within a set of variables to achieve an acceptable product, based on the final application requirements. The variables include the wavelength, irradiance, time of the UV radiation and temperature of the radiation target (i.e. film and/or ink). For example, most UV printing processes utilize UV radiation from LED lamps that emit an irradiance of about 50 W/cm² at a wavelength of 365 and/or 390 nm. The processor must ensure that the printed web travels through the curing station at a speed such that enough irradiance impacts the ink to effectively cure, or at least kick off the curing reaction. Other options exist for UV radiation sources, including high intensity, wide spectrum lamps such as high pressure mercury lamps.

As mentioned, temperature may play a role in the kinetics of the UV curing reaction. Depending on the ink and UV light source used, a slightly elevated temperature may be necessary to achieve curing at an acceptable rate. Temperature may also play a role in the extent of curing and bond level achieved. Increasing the temperature at which the curing is occurring may be achieved by heating the web slightly just prior to UV exposure. For example, the combination of the first film, the ink and the second film may be heated by passing the combination over a heated roller before it enters the UV exposure chamber. In eases where the first film and the second film are attached to each other just prior to the second UV exposure, the temperature of the web may be adjusted by heating the rolls used to nip the films together. If the film is traveling at a high speed through the machine, it may be necessary to have the rollers at a fairly high temperature to effectively raise the temperature of the film/ink combination to a suitable range. For example, the roller may be set at 300° F. to heat the web traveling at 100 ft/min to about 140° F. This is dependent on the amount of “wrap” the web has on the roller, or the length of surface of the roller that the web touches as it passes, as well as the speed of the web.

Often, the ink curing reaction is exothermic, effectively raising the temperature of the ink and any films in contact with the ink. In some cases, cooling rolls may be used to keep the temperature of the film at a level to avoid issues such as material degradation or sticking.

The first UV radiation may impinge the web (i.e. film, ink or a combination of these) from any direction. Typically, UV curing of the ink is done by exposing the ink directly to the UV radiation, without an intervening film. In other words, the UV radiation source is on the same side of the first film as the ink, directed toward the surface of the first film upon which the ink has been applied. However, if the first film is transparent to the type of UV radiation being used, the radiation may be applied through the opposite side of the first film, still affecting the ink and beginning the ink cure process. It is also contemplated that the first UV radiation may impinge the first film from both sides by using two separate UV radiation sources placed on either side of the web.

In addition to curing the ink, the UV radiation may also influence the films that are in the path of the radiant energy. Different polymers react to different wavelengths of energy in different ways. In some cases, the polymers are unchanged. In other cases, the bonds of the polymer may undergo scission. In still other cases, bonds of the polymer may react with other bonds, causing polymer cross-linking or rearrangement. The change in a polymer under exposure to UV energy may be evident by various physical changes, such as yellowing. When a polymer film does change under UV radiation, the polymer may absorb some or all the energy, and the polymer may be considered partially or fully “UV blocking”. If a polymer film absorbs all the UV energy, no UV radiation travels through the film and the film is opaque to UV energy.

After the first film has been printed, the second film is attached to the first film such that the ink is trapped between the first film and the second film. The attachment is done so that the ink is in direct contact with the first film and the ink is in direct contact with the second film. The attachment can be done by any known process, as long as a surface of the second film is brought into intimate contact with the ink that has been applied to the first film. As shown in FIG. 3, the attachment may be done by a nip roller 130, applying pressure to the films. Advantageously, a nipping type of attachment process can help to remove any air that might be entrapped between the webs, increasing the contact between the films.

While not always necessary, it may be useful to heat either the first film or the second film or both films as they are being attached to each other. This may assist in achieving good wetting between the surfaces. However, the temperatures used preferably are not above the softening point of the surfaces of the films that are being attached.

Excessive temperatures at the point of attachment (i.e. temperatures above the softening point of the materials or even above the melting point of the materials) should be avoided. The high temperatures, such as those high enough to achieve thermal lamination, can be detrimental to the materials within the laminate. The embodiments of the process to produce adhesive-free laminates disclosed herein avoid excessive temperatures. Only low temperature increases are necessary for the disclosed processes to result in acceptable laminates. The temperature of the laminate should not exceed 250° F. In some cases, no additional heat is required through the production process.

Following the attachment of the second film to the first film, the material is subjected to a second UV radiation. The second radiation step typically increases the bonds between the UV radiation sensitive ink and the first film as well as establishing the bonds between the UV radiation sensitive ink and the second film. Additionally, any ink curing that was not completed during the first UV radiation exposure is completed during the second UV radiation exposure. Especially important during the second UV radiation step is to increase the bond strength between the ink and the second film. In some cases, prior to the second UV radiation, the bond strength between the ink and the second film is at or near zero.

As with the first UV radiation exposure, it may be beneficial to increase the temperature of the laminate prior to the second UV radiation exposure. A higher temperature may change the rate of the reactions so that the ink curing and bonding occur faster and at to a greater extent. The second UV radiation exposure may be most efficient when the laminate temperature is between 100° F. and 200° F. In some embodiments of the adhesive-free laminate process, the laminate may not be heated and may even be cooled prior to the second UV radiation exposure.

As with the first UV radiation, the second UV radiation can impinge the film structure from either the side of the first film or the side of the second film, or both. If one of the first film or the second film is more transparent to UV radiation, it will likely be more efficient to direct the radiation from that side of the structure. In most cases, it will be most beneficial to impinge the second UV radiation through the second film such that it can be at least partially absorbed at or near the interface of the ink and the second film.

The process of producing the adhesive-free laminates includes two separate UV radiation exposures. The first UV radiation exposure occurs after the first film has been printed with the UV radiation sensitive ink. The second UV radiation exposure occurs after the second film has been attached to the first film. Both the first and second UV radiation may occur after the second film has been attached to the first film. Alternatively, the first UV radiation may occur prior to attachment of the second film to the first film.

When UV radiation exposure occurs after the second film has been attached to the first film, it has the advantage of excluding atmospheric oxygen from the ink-film interfaces. Because oxygen is known to consume, i.e., react with free radicals, it may be advantageous for at least one UV exposure to take place after the second film has been attached to the first film.

Some embodiments of the process to produce the adhesive-free lamination include the attachment of the second film to the first film directly after printing the first film, without curing the ink. Essentially, the ink is “wet” as there has been no UV exposure to begin the curing and increase the viscosity of the ink. This order of events can be beneficial to bonding as it allows for a very good wetting of the ink on the surface of the second film.

### Examples & Data

### Data 1

A white BOPP film was printed with a UV sensitive overlaquer ink (Fujifilm 300-HGV). The UV radiation sensitive ink was exposed to a first UV radiation such that the ink was partially cured, remaining just slightly tacky. One-inch strips of the printed film were cut from the web and overlaid with a one-inch strip of clear BOPP (CTL75) such that the ink was between the first (white) and second (clear) BOPP films. This sandwich was placed in a hydraulic lab press (Carver Press) and subjected to 1 ton of pressure at ambient lab temperature (no additional heat) to ensure good contact of the films. Several sample laminates were made according to this procedure.

A strip of the laminate was then attached to a hot plate inside of a lab crosslinking unit (Spectrolinker™ XL-1500 UV Crosslinker). The samples were subjected to a second UV radiation source of 254 nm for approximately 40 seconds, the radiation impinging the laminate from the clear BOPP side. The hot plate was either off (test run at ambient temperature, roughly 70° F.) or set to temperatures ranging from 100° F. to 200° F.

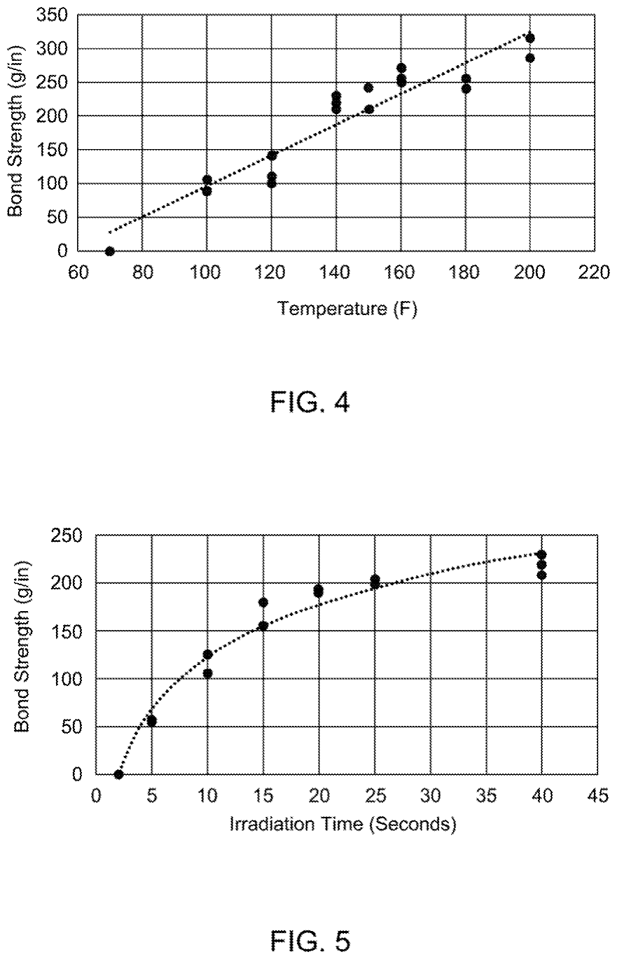

The bonds of this material were tested using a tensile testing unit (MTS Insight®, MTS Systems Corporation), separating the white BOPP from the BOPP film in a 180° peel. Data from this bond testing can be seen in FIG. 4. The data indicates that without excessive heat at the time of combining the films (not thermal lamination), an acceptable bond can be achieved by impinging a second UV radiation upon the laminate while the laminate is held at a slightly elevated temperature.

### Data 2

Sample laminates of white BOPP film/partially cured ink/clear BOPP film were prepared as described in Data 1. A second UV irradiation step was carried out under heated conditions (140° F.) while varying the radiation exposure times from 0 to 40 seconds. Bond strengths were measured on the resulting samples using the same 180° peel test described in Data 1. FIG. 5 summarizes the effect of radiation exposure on bonding and shows that high levels of adhesion can be achieved at temperatures significantly below the melting point or softening point of the BOPP film.

### Data 3

A first clear BOPP film was printed with a green pigmented UV radiation sensitive ink and subsequently (in-line) attached to a second clear BOPP to form a structure of BOPP/ink/BOPP. The first film was attached to the second film under unheated conditions. The UV radiation sensitive ink was not exposed to UV radiation until after the two films were brought together. In other words, the first film was attached to the second film while the UV radiation sensitive ink was still a liquid (uncured). Post lamination, the structure was exposed to a first UV radiation that impinged the laminate from the side of the second film. This first UV radiation source had an energy of 50 W/cm² and the laminate traveled past the radiation source at 300 ft/min. The laminate was not heated during the first UV radiation. Films A, B. C-1 through C-4 and D-1 through D-6 were made using this process for the first UV radiation step, modifying the intensity of the UV radiation as shown in Table 1.

The laminates were then either subjected to 1) no second UV radiation (samples C-1 and D-1), 2) a low intensity UV radiation through the first side of the laminate without any external heating (films A, B and D-2), 3) a high intensity, wide spectrum UV radiation through the laminate from the first side, while heating the web over a 140° F. roller (films C-2, D-3 and D-4) or 4) a bench top UV box at 254 nm for 40 seconds (films C-3, C-4, D-5 and D-6).

The processing conditions t tr each sample the resulting bond strengths are summarized in Table 1.

TABLE 1
Summary of Samples Laminated with Uncured Ink (ail
samples have the structure of BOPP/UV ink/BOPP

| | | Second UV Radiation Conditions | | | | | |
|---|---|---|---|---|---|---|---|
| | | | | Wide | Bench Top, | | |
| | First UV | | Low | Spectrum, | 254 nm, 40 | | Bond |
| | Radiation | | Intensity | High | seconds (side | | Strength |
| Sample | Intensify | None | UV | Intensity | impinged) | Heated? | (g/in) |
| A | 28% | | X | | | No | 60 |
| B | 50% | | X | | | No | 70 |
| C-1 | 85% | X | | | | — | 0 |
| C-2 | 85% | | | 50 ft/min | | 140° F. hot | 190 |
| | | | | | | roller | |
| C-3 | 85% | | | | First Film | 140° F. hot | 100 |
| | | | | | | plate | |
| C-4 | 85% | | | | Second Film | 140° F. hot | 110 |
| | | | | | | plate | |
| D-4 | 100% | X | | | | — | 0 |
| D-2 | 100% | | X | | | No | 110 |
| D-3 | 100% | | | 50 ft/min | | 140° F. hot | 200 |
| | | | | | | roller | |
| D-4 | 100% | | | 300 ft/min | | 140° F. hot | 115 |
| | | | | | | roller | |
| D-5 | 100% | | | | First Film | 140° F. hot | 160 |
| | | | | | | plate | |
| D-6 | 100% | | | | Second Film | 140° F. hot | 110 |
| | | | | | | plate | |

The data shown in Table 1 indicates the necessity of using two UV radiation steps for adhesive-free laminates. Samples C-1 and D-1 were exposed to only one UV radiation, resulting in a laminate with insufficient bond (zero bond strength). Comparatively, all of the other samples that incorporated a second UV radiation had improved bonds.

Overall, the data of Table 1 shows that curing the ink prior to lamination is not necessary to achieve strong bonding. Increasing light intensity (C-2, D-3 and D-4) and exposure time (B vs D-2) increased bond strength regardless of other conditions. Subsequent exposure to low and high intensity lights improved bonding significantly, with heat and higher intensity UV exposure producing the strongest bonds.

### Embodiments

A. An adhesive-free laminate structure comprising,
   a a first film;
   b a second film; and
   c an ink, the ink located between the first film and the second film;
      wherein the ink is adhered to a surface of the first film and the, ink is adhered to a surface of the second film; and
      wherein each of the first film and the second film are oriented.
B. The adhesive-free laminate structure according to any other embodiment, wherein the ink has been cured by a radiation source having a wavelength of between 200 nm and 400 nm.
C. The adhesive-free laminate structure according to any other embodiment, wherein the bond between the ink and the second film has been increased by exposure to radiation.
D. The adhesive-free lamination structure according any other embodiment, wherein the ink is configured to relay a visual message.
E. The adhesive-free laminate structure according to any other embodiment, wherein the bonds measured between the second film and the ink is at least 50 g/in.
F. The adhesive-free laminate structure according to any other embodiment, wherein the first film is biaxially oriented polypropylene or biaxially oriented polyester.
G. The adhesive-free laminate structure according to any other embodiment, wherein the second film is biaxially oriented polypropylene or biaxially oriented polyester.
H. The adhesive-free laminate structure according to any other embodiment, therein the surface of the second film that is in contact with the ink has a softening point above 250° F.
I. The adhesive-free laminate structure according to any other embodiment wherein the ink is coextensive with both the first film and the second film.
J. A process to produce an adhesive-tree laminate comprising,
   a printing a UV radiation sensitive ink on a surface of a first film;
   b exposing the first film and the UV radiation sensitive ink to a first UV radiation such that the UV radiation sensitive ink is at least partially cured;
   c attaching the first film to a second film such that the UV radiation sensitive ink is between the first film and the second film and the UV radiation sensitive ink is in direct contact with a surface of the second film; and
   d exposing the combination of the first film, the UV radiation sensitive ink and the second film to a second UV radiation.
K. The process to produce an adhesive-free laminate according to embodiment J, wherein the first film is an oriented film and the second film is an oriented film.
L. The process to produce an adhesive-free laminate according to embodiment J or K, wherein the first UV radiation and the second UV radiation impinge opposite sides of the UV radiation sensitive ink.
M. The process to produce an adhesive-free laminate according to any of embodiments J or K, wherein the first UV radiation and the second UV radiation impinge the same side of the UV radiation sensitive ink.
N. The process to produce an adhesive-free laminate according to any of embodiments J-M, wherein the UV radiation sensitive ink is less than fully cured upon exposure to the first UV radiation and the second UV radiation is employed when the combination of the first film, the UV radiation sensitive ink and the second film is at a temperature between about 100° F. and 200° F.
O. An adhesive-free laminate produced by the process of any of the embodiments of J-N, wherein both the first and second films are each a biaxially oriented polypropylene.
P. A process to produce an adhesive-free laminate comprising,
   a. as first step of printing a UV radiation sensitive ink fill a surface of a first film;
   b. a second step of exposing the first film to a first UV radiation such that the UV radiation sensitive ink is at least partially cured;
   c. a third step of attaching the first film to a second film such that the UV radiation sensitive ink is between the first film and the second film and the UV radiation sensitive ink is in direct contact with a surface of the second film; and
   d. a fourth step of exposing the combination of the first film, the UV radiation sensitive ink and the second film to a second UV radiation such that the bonds measured when separating the first film and the second film are between 100 g/in and 500 g/in.
Q. The process to produce an adhesive-free laminate according to embodiment P, wherein the fourth step includes heating the combination of the first film, the UV radiation sensitive ink and the second film using an external heating source immediately prior to exposure to the second UV radiation.
R. The process to produce an adhesive-free laminate according to embodiment P or Q, wherein the third step is carried out when the second film is at a temperature below the softening point of the surface of the second film.
S. The process to produce an adhesive-free laminate according to embodiment P, Q or R, wherein the UV radiation sensitive ink is less than fully cured during the second step.
T. The process to produce an adhesive-free laminate according to any of embodiments P-S, wherein both the first and second films are oriented films.

What is claimed is:

1. An adhesive -free laminate structure comprising,
a. a first film;
b. a second film; and
c. an ink, the ink located between the first film and the second film;
wherein the ink is adhered to a surface of the first film and the ink is adhered to a surface of the second film; and
wherein each of the first film and the second film are oriented.

2. The adhesive-free laminate structure according to claim 1, wherein the ink has been cured by a radiation source having a wavelength of between 200 nm and 400 nm.

3. The adhesive-free laminate structure according to claim 1, wherein the bond between the ink and the second film has been increased by exposure to radiation.

4. The adhesive-free lamination structure according to claim 1, wherein the ink is configured to relay a visual message.

5. The adhesive-free laminate structure according to claim 1, wherein the bonds measured between the second film and the ink is at least 50 g/in.

6. The adhesive-free laminate structure according to claim 1, wherein the first film is biaxially oriented polypropylene or biaxially oriented polyester.

7. The adhesive-free laminate structure according to claim 1, wherein the second film is biaxially oriented polypropylene or biaxially oriented polyester.

8. The adhesive-free laminate structure according to claim 1, wherein the surface of the second film that is in contact with the ink has a softening point above 250° F.

9. The adhesive-free laminate structure according to claim 1, wherein the ink is coextensive with both the first film and the second film.

10. A process to produce an adhesive-free laminate comprising,
a. printing a UV radiation sensitive ink on a surface of a first film;
b. exposing the first film and the UV radiation sensitive ink to a first UV radiation such that the UV radiation sensitive ink is at least partially cured;
c. attaching the first film to a second film such that the UV radiation sensitive ink is between the first film and the second film and the UV radiation sensitive ink is in direct contact with a surface of second film; and
d. exposing the combination of the first film, the UV radiation sensitive ink and the second film to a second UV radiation.

11. The process to produce an adhesive-free laminate according to claim 10, wherein the first film is an oriented film and the second film is an oriented film.

12. The process to produce an adhesive-free laminate according to claim 10, wherein the first UV radiation and the second UV radiation impinge opposite sides of the UV radiation sensitive ink.

13. The process to produce an adhesive-free laminate according to claim 10, wherein the first UV radiation and the second UV radiation impinge the same side of the UV radiation sensitive ink.

14. The process to produce an adhesive-free laminate according to claim 10, wherein the UV radiation sensitive ink is less than fully cured upon exposure to the first UV radiation and the second UV radiation is employed when the combination of the first film, the UV radiation sensitive ink and the second film is at a temperature between about 100° F. and 200° F.

15. An adhesive-free laminate produced by the process of claim 10, wherein both the first and second films are each a biaxially oriented polypropylene film.

16. A process to produce an adhesive-free laminate comprising,
a. a first step of printing a UV radiation sensitive ink on a surface of a first film;
b. a second step of exposing the first film to a first UV radiation such that the UV radiation sensitive ink is at least partially cured;
c. a third step of attaching the first film to a second film such that the UV radiation sensitive ink is between the first film and the second film and the UV radiation sensitive ink is in direct contact with a surface of the second film; and
d. a fourth step of exposing the combination of the first film, the UV radiation sensitive ink and the second film to a second UV radiation such that the bonds measured when separating the first film and the second film are between 100 g/in and 500 g/in.

17. The process to produce an adhesive-free laminate according to claim 16, wherein the fourth step includes heating the combination of the first film, the UV radiation sensitive ink and the second film using an external heating source immediately prior to exposure to the second UV radiation.

18. The process to produce an adhesive free laminate according to claim 16, wherein the third step is carried out when the second film is at a temperature below the softening point of the surface of the second film.

19. The process to produce an adhesive-free laminate according to claim 16, wherein the UV radiation sensitive ink is less than fully eared during the second step.

20. The process to produce an adhesive-free laminate according to claim 16, wherein both the first and second films are oriented films.
